(19) United States
(12) Patent Application Publication
(10) Pub. No.: US 2026/0287749 A1
(43) Pub. Date: Sep. 24, 2026

(54) SYSTEM AND METHOD FOR POSITION, NAVIGATION, AND TIMING (PNT) INTEGRITY MONITORING

(71) Applicant: Everywhere Communications, Inc., Annapolis, MD (US)

(72) Inventors: Brian Stam, Yarmouth, ME (US); Bruci Lopez, Leesburg, VA (US); Eric Semle, Gorham, ME (US)

(73) Assignee: Everywhere Communications, Inc., Annapolis, MD (US)

(21) Appl. No.: 19/387,486

(22) Filed: Nov. 12, 2025

Related U.S. Application Data
(60) Provisional application No. 63/719,431, filed on Nov. 12, 2024.

(51) Int. Cl. G01S 19/07

(52) U.S. Cl. CPC G01S 19/07

(57) ABSTRACT

A method and system of monitoring location tracking wherein the system receives location data about a navigation device based on position, navigation, timing (PNT) signals received by the navigation device from one or more satellites. The location data includes a PNT geographic location of the navigation device. The system receives metadata associated with the location data and communication of the location data to the one or more satellites and a monitoring system. The system analyzes the location data and the metadata by applying one or more test criteria. The test criteria utilizes historical geographic location data about the navigation device and a predetermined location-based threshold. Upon determining that a result of the one or more test criteria indicates a disruption condition of the PNT signals, the system executes a countermeasure at the navigation device.

### RELATED APPLICATIONS

This application claims priority to U.S. Prov. Application Ser. No. 67/719,431 filed on Nov. 12, 2024, which is expressly incorporated herein by reference in its entirety for all purposes.

### TECHNICAL FIELD

The present disclosure generally relates to a system for detecting disruption of position, navigation, and timing (PNT) signals and method of operating same, and more particularly, a system that receives and traces one or more input signals and analyzes the signals for a disruption to provide one or more counteractions.

### BACKGROUND

Many navigation, communication, and timing infrastructures rely on position, navigation, and timing (PNT) data obtained from Global Navigation Satellite Systems (GNSS). These satellite systems transmit signals to receivers to determine position, velocity, and time. PNT signals are used in many applications, for example, mobile device navigation and aviation.

Disruptions to PNT signals pose a threat to systems that depend on accurate PNT data. For example, jamming, spoofing, environment effects, and other system faults can lead to inaccurate PNT data. It is important for systems that rely on PNT data to have detection processes in place to detect system vulnerabilities and disruptions.

### BRIEF DESCRIPTION

According to one aspect, a computer-implemented method of position, navigation, and timing (PNT) integrity monitoring, includes receiving location data about a navigation device based on PNT signals received by the navigation device from one or more satellites. The location data includes a PNT geographic location of the navigation device. The method includes receiving metadata associated with the location data and communication of the location data to the one or more satellites and a monitoring system. The method includes analyzing the location data and the metadata by applying one or more test criteria. Each test criteria utilize historical geographic location data about the navigation device and a predetermined location-based threshold. Upon determining that the result of the one or more test criteria indicates a disruption condition of the PNT signals, the method includes executing a countermeasure at the navigation device.

According to another aspect, a system for monitoring position, navigation, and timing (PNT) integrity includes a navigation device for receiving PNT signals from one or more satellites. The navigation device generates location data based on the PNT signals. The location data includes a PNT geographic location of the navigation device. The system includes a monitoring system for receiving the location data and metadata associated with the location data and communication of the location data to the one or more satellites and a monitoring system. The system includes a processor operatively connected for computer communication to the navigation device and the monitoring system. The processor analyzes the location data and the metadata by applying one or more test criteria. Each test criteria utilize historical geographic location data about the navigation device and a predetermined location-based threshold. Upon determining that a result of the one or more test criteria indicates a disruption condition of the PNT signals, the processor executes a countermeasure at the navigation device.

According to a further aspect, a non-transitory computer-readable storage medium storing instructions that, when executed by a monitoring system, cause the monitoring system to perform a process for position, navigation, and timing (PNT) integrity monitoring, including, receiving location data about a navigation device based on PNT signals received by the navigation device from one or more satellites. The location data includes a PNT geographic location of the navigation device. Receiving metadata associated with the location data and communication of the location data to the one or more satellites and the monitoring system. Analyzing the location data and the metadata by applying one or more test criteria. Each test criteria utilize historical geographic location data about the navigation device and a predetermined location-based threshold. Upon determining that a result of the one or more test criteria indicates a disruption condition of the PNT signals, executing a countermeasure at the navigation device.

### BRIEF DESCRIPTION OF THE DRAWINGS

The accompanying drawings, which are incorporated in and constitute a part of the specification, illustrate various systems, methods, devices, and other embodiments of the disclosure. It will be appreciated that the illustrated element boundaries (e.g., boxes, groups of boxes, directional lines, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1A is a schematic diagram of a system implementing PNT monitoring according to one embodiment;

FIG. 1B is a schematic diagram of a magnified view of a random tracked location supported by the system shown in FIG. 1A;

FIG. 2 is a block diagram of a monitoring platform according to one embodiment;

FIG. 3 is a flowchart of a method for position, navigation, and timing (PNT) integrity monitoring according to one embodiment; and

FIG. 4 is a flowchart of a method for analyzing the location data and the metadata according to one embodiment.

### DETAILED DESCRIPTION

The embodiments described herein are directed to position, navigation, and timing (PNT) monitoring for mobile devices (e.g., navigation devices), and more specifically, to receiving and analyzing PNT signals and derived data to determine a disruption condition of the PNT signals and executing a countermeasure at a mobile device. Mobile devices, for example navigation devices and satellite communication devices, utilize PNT signals transmitted by satellites to determine their location and other navigation related data. Disruptions that corrupt or delay PNT signals (e.g., jamming, spoofing, environment effects, and other system faults) can cause a receiver of the mobile device to output inaccurate or inconsistent location information. This can create significant consequences for users of these mobile devices and other systems that rely on the mobile device. For example, incorrect location reporting can mislead rescue services during an SOS event, impair trip logging, geofencing, or safety notifications, among others.

Some systems may detect PNT disruptions using data directly from mobile devices. For example, mobile devices or other server-side systems can run integrity checks on GNSS fixes and sensor-based location data. However, such approaches can be unreliable because they rely on device-level data and processing, which may be compromised, and lack contextual or comparative data. Additionally, these approaches tend to be high power, complex, and expensive, typically directed to military or aviation systems.

Accordingly, the technology disclosed herein provides a technological improvement of these monitoring systems by overlaying multiple types of communication signals and does not require disruption of the data and systems of the mobile device. More specifically, by monitoring communication signals between multiple entities, deriving metadata about the PNT signals, utilizing historical location data, and applying test criteria, disruption conditions are more effectively determined and addressed. Additionally, by leveraging signals and data already present, this approach can reduce costs and avoid the need for additional specialized hardware.

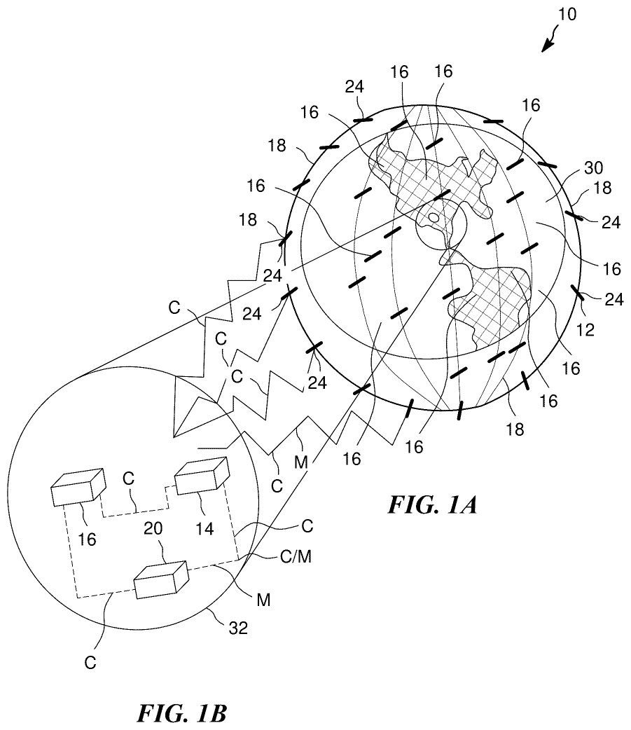

Referring now to the drawings, wherein the showings are for purposes of illustrating one or more exemplary embodiments and not for purposes of limiting same, FIG. 1A is a schematic diagram of a system 10 implementing PNT monitoring according to one embodiment. The system 10 operates throughout the world or planet Earth 30. The planet 30 is surrounded by a satellite communications network 12 comprising one or more satellites 24 that orbit about the earth in a geosynchronous orbit 18. FIG. 1B is a magnified view of a random tracked location 32 that could be anywhere on the planet Earth 30, which is supported by the system 10.

The tracked location 32 includes a navigation device 16, a satellite transceiver 14, and a monitoring system 20. The navigation device 16, satellite transceiver 14 and monitoring system 20 are all in operable computer communication “C” with each other via any number of communication protocols that would be know by those having skill in the art. Similarly, the satellite transceiver 14 is in operable computer communication “C” with any and/or all of the satellites 24. In one example embodiment, the navigation device 16 is, for example, the Garmin inReach Mini 2. In one example embodiment, the satellite transceiver 14 is the Iridium 9603, and the satellite communications network 12 is an Iridium Satellite.

In one example embodiment, the system 10 includes the navigation device 16, satellite transceiver 14, satellite communication network 12, and monitoring system 20. The navigation device 16 is moving through the physical world and updates its internally stored position-navigation-timing (PNT) location using all available sources, including GNSS, other satellite communication networks 12, mobile phone location engines, and the like. Periodically, these locations (i.e., location data including a PNT geographic location of the navigation device 16 are transmitted (i.e. communicated C) back to the monitoring system 20 using the satellite communication network 12. As will be discussed in more detail herein, these communication “C” signals include network metadata M (e.g., timestamp, signal strength) about the transmissions and location data.

The monitoring system 20 processes the signals from the navigation device 16 based on applying one or more test criteria utilizing historical data about the navigation device 16 stored at the monitoring system 20. Based on these test criteria, which will be discussed in further detail herein, PNT signal disruptions are detected and the monitoring system 20 will generate one or more countermeasures (e.g., an alert).

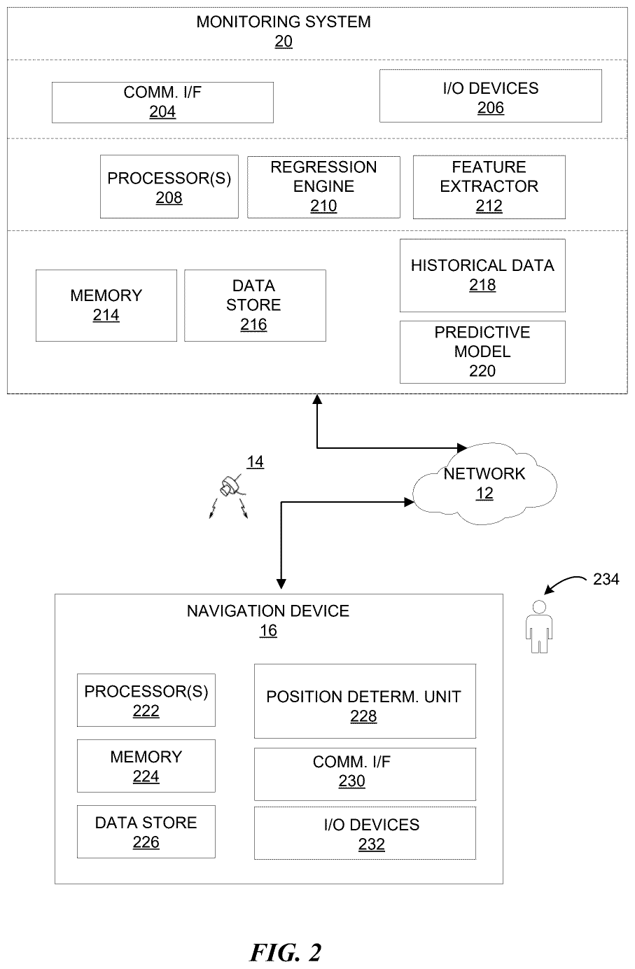

FIG. 2 illustrates an exemplary block diagram of hardware and logic components of the system 10 of FIGS. 1A and 1B, namely, the monitoring system 20 and the navigation device 16. Generally, the monitoring system 20 includes processor(s) 208, a regression engine 210, a feature extractor 212, a memory 214, a data store 216, historical data 218, predictive model 220 a communication interface (I/F) 204, and input/output devices 206, where are each operably connected for computer communication via a wired or wireless technology discussed herein.

The monitoring system 20 can include provisions for processing, communicating, and interacting with various components of the monitoring system 20 and other components of the system 10 including the navigation device 16. In particular, the processor(s) 208 can include logic circuitry with hardware, firmware, and software architecture frameworks for facilitating control of the monitoring system 20 and communication between the monitoring system 20 and other components of the system 10. Thus, in some embodiments, the processor(s) 208 can store application frameworks, kernels, libraries, drivers, application program interfaces, among others, to execute and control hardware and functions discussed herein. For example, the processor(s) 208 can store and/or execute the regression engine 210 and/or the feature extractor 212. The regression engine 210 can include various test criteria, as will be described herein, used to analyze information from communication C signals and metadata M against historical data (e.g., the historical data 218) and/or form or apply the predictive model 220.

In some embodiments, the memory 214 and/or the data store (e.g., disk) 216 can store similar components as the processor(s) 208 for execution by the processor(s) 208. The historical data 218 is previously recorded and/or collected information (e.g., location data, metadata) related to the geographic position and navigation of the navigation device 16. For example, location data, PNT geographic location are periodically transmitted from the navigation device 16 to the monitoring system 20 using the satellite communication network 12 and can be stored at the monitoring system 20 as historical data 218. Metadata (e.g., signal strength, time stamped locations) associated with these transmissions can be generated by the satellite communication network 12 and also transmitted and stored at the monitoring system 20 as historical data 218. The historical data 218 can be used to determine baseline thresholds, motion patterns, or signal quality characteristics for the navigation device 16 over time. It is understood that location data and historical data 218 can be obtained from various sources, including third-parties. For example, mobile networks, satellite internet networks, and other GNSS systems.

Accordingly, subsequently received location data can be compared and/or analyzed to the historical data 218 to detect a disruption condition. For example, as will be discussed in further detail herein, based on the analysis executed by the regression engine 210 using the historical data 218 and the predictive model 220, the predictive model 220 can determine and/or output a disruption condition, and the processor 208 via the communication I/F 204 can then execute one or more counteractions, for example, transmitting an alert to the navigation device 16.

The communication I/F 204 can include software and hardware to facilitate data input and output between the components of the monitoring system 20 and other components of the system 10. Specifically, the communication I/F 204 can include network interface controllers (not shown) and other hardware and software that manages and/or monitors connections and controls bi-directional data transfer between the communication I/F 204 and other components of the system 10 using, for example, the network 12. As another example, the communication I/F 204 can facilitate communication (e.g., exchange data and/or transmit messages) with the satellite transceiver 14 and the navigation device 16. Input/output devices 206 provide input to the processor(s) 222 and/or output to other components of the system 10.

The navigation device 16 includes processors(s) 222, a memory 224, a data store 226, a position determination unit 228, a communication interface (I/F) 230, and input/output devices 232. The navigation device 16 is associated with a first user 152. As an illustrative example, the navigation device 16 is a portable device in possession of the first user 152. The navigation device 16 can include provisions for processing, communicating, and interacting with various components of the navigation device 16 and other components of the system 10, for example, the monitoring system 20 and the satellite transceiver 14. The processor(s) 222 can include logic circuitry with hardware, firmware, and software architecture frameworks for facilitating control of the navigation device 16 and communication between the navigation device 16 and other components of the system 10. Thus, in some embodiments, the processor(s) 222 can store application frameworks, kernels, libraries, drivers, application program interfaces, among others, to execute and control hardware and functions discussed herein. In some embodiments, the memory 224 and/or the data store (e.g., disk) 226 can store similar components as the processor(s) 222 for execution by the processor(s) 222.

The position determination unit 228 can include hardware (e.g., sensors) and software to determine and/or acquire position data about the navigation device 16. For example, the position determination unit 228 can include a global positioning system (GPS) and GPS receivers (not shown) and/or an inertial measurement unit (IMU) (not shown). Thus, the position determination unit 228 can provide geodata (i.e., location data, PNT geographical location) about the navigation device 16 based on satellite data from, for example, the satellite transceiver 14 and/or the network 12, or from any Global Navigational Satellite infrastructure (GNSS), including GPS, Glonass (Russian) and/or Galileo (European). In some embodiments, the position determination unit 228 can provide dead-reckoning data or motion data from, for example, a gyroscope, accelerometer, magnetometers, among other sensors (not shown).

The communication I/F 230 can include software and hardware to facilitate data input and output between the components of the navigation device 16 and other components of the system 10. Specifically, the communication I/F 128 can include network interface controllers (not shown) and other hardware and software that manages and/or monitors connections and controls bi-directional data transfer between the communication I/F 128 and other components of the system 10 using, for example, the network 12. Input/output devices 232 provide input to the processor(s) 222 and/or output to other components of the system 10.

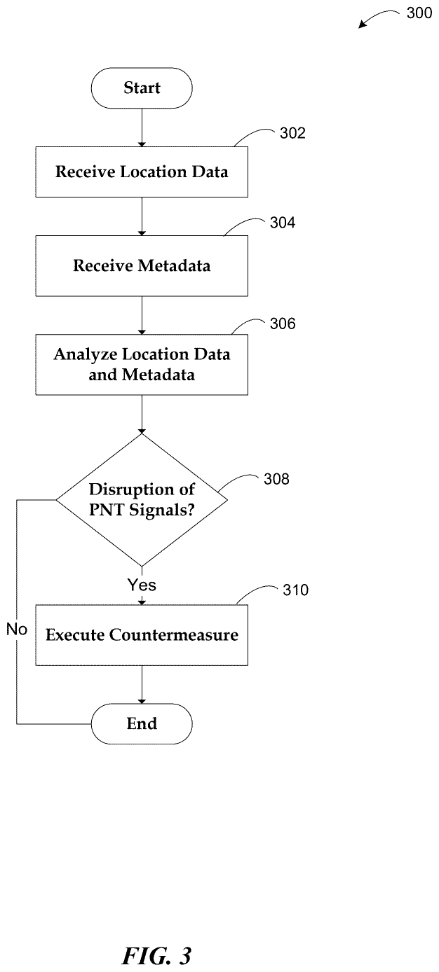

Referring now to FIG. 3, a method for position, navigation, and timing (PNT) integrity monitoring is shown. The blocks of FIG. 3 will be discussed with reference to the components shown in FIGS. 1A, 1B, and 2. At block 302, the method 300 includes receiving location data about the navigation device 16 based on PNT signals received by the navigation device from the satellite transceiver 14. The location data includes a PNT geographic location of the navigation device 16. More specifically, the navigation device 16 via the processor 222 generates location data including, but not limited to, latitude and longitude (e.g., coordinates), altitude, course, speed, and time stamp. The PNT geographic location can be based on the location data. The location data is stored at the navigation device 16, for example, the data store 226, and is continuously sampled by the satellite 24 and/or the network 12. The location data can be transmitted to the monitoring system 20 via the satellite communication network 12.

At block 304, the method 300 includes receiving metadata associated with the location data and communication of the location data to the one or more satellite transceivers 14 and the monitoring system 20. The location data discussed above is sent from the satellite transceiver 14 to the network 12. The network 12 receives the communications C and relays the communications C to the monitoring system 20, along with corresponding metadata M. The messages C, M are received by the monitoring system 20 as IP packets P, which are then deserialized. In one embodiment, the metadata is generated by the satellite network 12 and is associated with the location data transmitted from the navigation device 16. The metadata can include, but is not limited to, the sending device identification information (e.g., IMEI), timestamp, size of the message, location (e.g., latitude, longitude coordinates), statistical accuracy metrics (e.g., Circular Error Probable (CEP)).

In one embodiment, the metadata includes a received transmission time (e.g., a timestamp) when the location data is received by the satellite communication network 12 and/or the receiver 14. The metadata can also include a transmission time (e.g., a timestamp) the location data is sent from the satellite communication network 12 to the monitoring system 20. The metadata can also include an estimated location of the navigation device 16 determined by the satellite communication network 12.

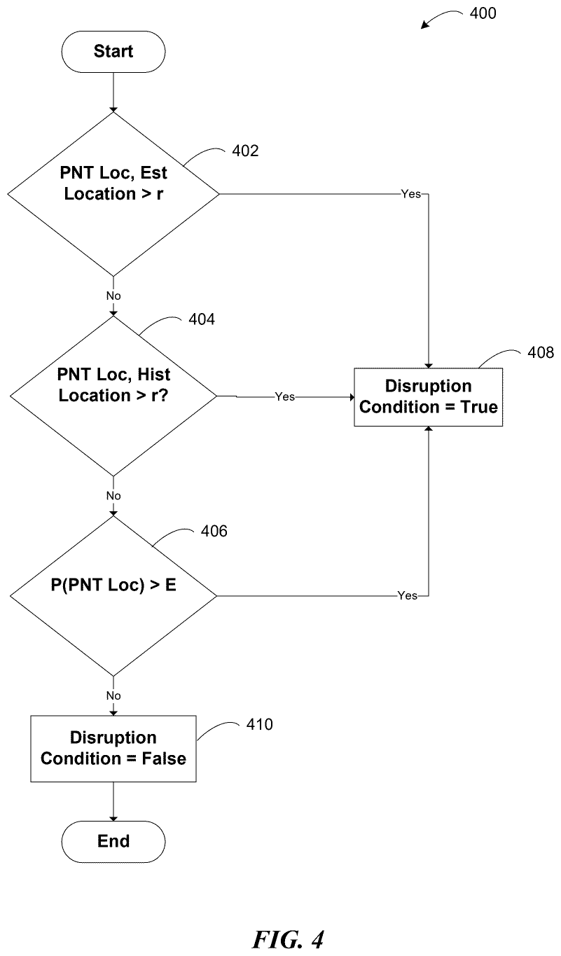

At block 306, the method 300 includes analyzing the location data and the metadata. More specifically, the monitoring system 20 applies one or more test criteria on the packets P, including the messages C, M. The test criteria utilize historical geographic location data about the navigation device 16, for example, the historical data 218. Additionally, the test criteria include predetermined location-based thresholds. Based on the analysis at block 306, it is determined if a result of the one or more test criteria indicates a disruption condition of the PNT signals at block 308. Blocks 306 and 308 will now be discussed in more detail with FIG. 4.

FIG. 4 illustrates a 400 method for analyzing the location data and the metadata according to one illustrative embodiment. In FIG. 4, three test criteria (e.g., inquiries) are shown. However, it is understood that the analysis can be based on one or more of the test criteria.

At block 402 the method 400 includes comparing the PNT geographic location to an estimated location of the navigation device determined by the satellite communication network 12. If the PNT geographic location is outside a predetermined radius threshold (r) relative to the estimated location of the navigation device determined by the communication satellite (YES), a disruption condition is found and set to TRUE.

Otherwise, the method proceeds to block 404 where, the method 400 includes comparing the PNT geographic location to the previously reported PNT geographic location (i.e., historical data 218). If the PNT geographic location is outside a predetermined radius threshold (r) relative to the previously reported PNT geographic location (YES), a disruption condition is found and set to TRUE.

At bock 406, the method 400 includes comparing the PNT geographic location to the previously reported PNT geographic location. If the PNT geographic location indicates unnatural movement compared to the previously reported PNT geographic location(YES), a disruption condition is found and set to TRUE. In some embodiments, determination of unnatural movement can be determined based on statistical deviation, vector distance, and/or a probabilistic model. For example, in one embodiment, if the PNT geographic location deviates from a historical baseline average of previously reported PNT geographic locations (e.g., stored at historical data 218) by a predetermined threshold, then unnatural movement is determined and the disruption condition is found to be TRUE.

It is understood that analysis of unnatural movement patterns that indicate a disruption condition can be performed by analyzing sequences of reported PNT geographic location and previously reported PNT geographic locations and identifying spatial or temporal inconsistencies with expected physical movement behavior. For example unnatural movement patterns that are indicative of a disruption condition (e.g., spoofing, other anomalies) can include, but are not limited to, repeated identical location coordinates over consecutive time intervals (e.g., static movement), repetition of coordinate sequences or trajectories (e.g., indicating replayed data), location coordinates that form geometrically uniform trajectories, for example, straight lines or uniform polygons (e.g., circles, squares) since these trajectories rarely occur in natural navigation paths, location coordinates that indicate zig-zag motion or abrupt directional changes, and/or location coordinates that indicate calculated velocities, accelerations, or trajectories exceed limits for a specific device and/or platform.

As shown in FIG. 4, if at least one of the blocks 402, 404, 406 indicates a disruption, the disruption condition (i.e., output of block 408) is TRUE. However, in other embodiments not shown, the disruption condition (i.e., the output of block 408) is set to TRUE only when two or three (i.e., all) of the blocks 402, 404, 406 indicate a disruption. Otherwise, the disruption condition is set to FALSE at block 410.

Referring again to FIG. 3, at block 310, the method 300 includes executing a countermeasure based on the disruption condition. For example, executing the countermeasure at the navigation device 16 includes transmitting an alert signal to the navigation device 16. More specifically, a disruption condition is detected (i.e., TRUE) the processor 208 generates an alert message that includes data identifying the disruption condition and the affected area (e.g., region, navigation device identification information). The communication I/F 204 can transmit the message to the navigation device 16 thereby causing the navigation device 16 to execute an alert routine. The alert routine can include rendering a visual or audio output via the I/O devices 232. In other embodiments, an alert message or event log can be transmitted to third-party emergency services servers (not shown) to alert local authorities or security. In some embodiments, the overmeasure executed is based on the type of disruption condition detected (e.g., at blocks 402, 404, and 406).

In one embodiment, transmitting a message and/or alert to the navigation device 16 can additionally provide suggested behaviors for shielding the navigation device 16. For example, the alert and/or message may include instructions to shield the navigation device 16 using terrain, buildings, vehicles, or even a user's body. The suggested behavior can be based on the type of disruption condition detected (e.g., at blocks 402, 404, and 406) and the current location of the navigation device 16.

In some embodiments, executing the countermeasure can include the monitoring system 20 executing a control signal to the navigation device 16 causing the navigation device 16 to execute a device level corrective routine. For example, exclude suspect signals from position determination, initiate a reacquisition to search for valid signals, enter an autonomous mode using only onboard sensor position data, among others. In some embodiments, the monitoring system 20 can exclude certain satellites from position determination and/or switch to alternative satellites and frequencies. Other countermeasures can include modifying geofenced locations and trip logging based on the detected disruption condition. The countermeasure techniques described enable efficient detection and mitigation of PNT disruptions, providing enhanced operational safety and continuity.

### DEFINITIONS

The following includes definitions of selected terms employed herein. The definitions include various examples and/or forms of components that fall within the scope of a term and that may be used for implementation. The examples are not intended to be limiting. Further, the components discussed herein, may be combined, omitted or organized with other components or into different architectures.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more computing devices (e.g., computer, personal digital assistant, cellular telephone, network device, vehicle, vehicle computing device, infrastructure device, roadside device) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless area network (WAN), a wide area network (WAN), a metropolitan area network (MAN), a virtual private network (VPN), a cellular network, a token ring network, a point-to-point network, an ad hoc network, a mobile ad hoc network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. A database may be stored, for example, at a disk and/or a memory.

“Disk,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Input/output devices,” as used herein may include, but are not limited to, a mouse, keyboard, a touchscreen, a touchpad, a wearable input device, a camera, a microphone, among others. The input/output devices can also include a display to display text and graphics. It is understood that other input/output devices can also be coupled to the processor(s), for example, disk drives, media devices, etc.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Operable connection,” or a connection by which entities are “operably connected,” is one in which signals, physical communications, and/or logical communications may be sent and/or received. An operable connection may include a wireless interface, a physical interface, a data interface, and/or an electrical interface.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

The embodiments discussed herein may also be described and implemented in the context of “computer-readable medium” or “computer storage medium.” As used herein, “computer-readable medium” or “computer storage medium refers to a non-transitory medium that stores instructions, algorithms, and/or data configured to perform one or more of the disclosed functions when executed. Computer-readable medium may be non-volatile, volatile, removable, and non-removable, media implemented in any method or technology for storage of information such as computer readable instructions, data structures, modules or other data. Computer-readable medium may include, but is not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device may interface with. Computer-readable medium excludes non-transitory tangible media and propagated data signals.

1. A computer-implemented method of position, navigation, and timing (PNT) integrity monitoring, comprising:
receiving location data about a navigation device based on PNT signals received by the navigation device from one or more satellites, wherein the location data includes a PNT geographic location of the navigation device;
receiving metadata associated with the location data and communication of the location data to the one or more satellites and a monitoring system;
analyzing the location data and the metadata by applying one or more test criteria, wherein each test criteria utilize historical geographic location data about the navigation device and a predetermined location-based threshold; and
upon determining that a result of the one or more test criteria indicates a disruption condition of the PNT signals, executing a countermeasure at the navigation device.

2. The computer-implemented method of claim 1, wherein the one or more satellites transmit the location data and the associated metadata to the monitoring system.

3. The computer-implemented method of claim 1, wherein the metadata includes timestamp data indicating transmission and receiving times associated with communicating the location data.

4. The computer-implemented method of claim 1, wherein the metadata includes an estimated location of the navigation device determined by the communication satellite based on the location data.

5. The computer-implemented method of claim 1, wherein the test criteria includes comparing the PNT geographic location to an estimated location of the navigation device determined by the communication satellite, and wherein the disruption condition is indicated when the PNT geographic location is outside a predetermined radius threshold relative to the estimated location of the navigation device determined by the communication satellite.

6. The computer-implemented method of claim 1, wherein the historical navigation device location data includes a previously reported PNT geographic location.

7. The computer-implemented method of claim 6, wherein the test criteria includes comparing the PNT geographic location to the previously reported PNT geographic location, and wherein the disruption condition is indicated when the PNT geographic location is outside a predetermined radius threshold relative to the previously reported PNT geographic location.

8. The computer-implemented method of claim 6, wherein the test criteria includes comparing the PNT geographic location to the previously reported PNT geographic location, and wherein the disruption condition is indicated when the PNT geographic location indicates unnatural movement compared to the previously reported PNT geographic location.

9. The computer-implemented method of claim 1, wherein executing the countermeasure at the navigation device includes transmitting an alert signal to the navigation device.

10. A system for monitoring position, navigation, and timing (PNT) integrity, comprising:
a navigation device for receiving PNT signals from one or more satellites, wherein the navigation device generates location data based on the PNT signals, wherein the location data includes a PNT geographic location of the navigation device;
a monitoring system for receiving the location data and metadata associated with the location data and communication of the location data to the one or more satellites and a monitoring system; and
a processor operatively connected for computer communication to the navigation device and the monitoring system, wherein the processor:
analyzes the location data and the metadata by applying one or more test criteria, wherein each test criteria utilize historical geographic location data about the navigation device and a predetermined location-based threshold; and
upon determining that a result of the one or more test criteria indicates a disruption condition of the PNT signals, executes a countermeasure at the navigation device.

11. The system of claim 10, wherein the metadata includes timestamp data indicating transmission and receiving times associated with communicating the location data, and an estimated location of the navigation device determined by the communication satellite based on the location data.

12. The system of claim 11, wherein the test criteria includes comparing the PNT geographic location to the estimated location of the navigation device, and wherein the disruption condition is indicated when the PNT geographic location is outside a predetermined radius threshold relative to the estimated location of the navigation device.

13. The system of claim 10, wherein the test criteria includes comparing the PNT geographic location to a previously reported PNT geographic location, and wherein the disruption condition is indicated when the PNT geographic location is outside a predetermined radius threshold relative to the previously reported PNT geographic location.

14. The system of claim 10, wherein the test criteria includes comparing the PNT geographic location to the previously reported PNT geographic location, and wherein the disruption condition is indicated when the PNT geographic location indicates unnatural movement compared to the previously reported PNT geographic location.

15. The system of claim 10, wherein executing the countermeasure includes transmitting an alert to the navigation device.

16. A non-transitory computer-readable storage medium storing instructions that, when executed by a monitoring system, cause the monitoring system to perform a process for position, navigation, and timing (PNT) integrity monitoring, the process comprising:
receiving location data about a navigation device based on PNT signals received by the navigation device from one or more satellites, wherein the location data includes a PNT geographic location of the navigation device;
receiving metadata associated with the location data and communication of the location data to the one or more satellites and the monitoring system;
analyzing the location data and the metadata by applying one or more test criteria, wherein each test criteria utilize historical geographic location data about the navigation device and a predetermined location-based threshold; and
upon determining that a result of the one or more test criteria indicates a disruption condition of the PNT signals, executing a countermeasure at the navigation device.

17. The non-transitory computer-readable storage medium of claim 16, wherein the test criteria includes comparing the PNT geographic location to an estimated location of the navigation device determined by the communication satellite, and wherein the disruption condition is indicated when the PNT geographic location is outside a predetermined radius threshold relative to the estimated location of the navigation device determined by the communication satellite.

18. The non-transitory computer-readable storage medium of claim 16, wherein the historical navigation device location data includes a previously reported PNT geographic location.

19. The non-transitory computer-readable storage medium of claim 18, wherein the test criteria includes comparing the PNT geographic location to the previously reported PNT geographic location, and wherein the disruption condition is indicated when the PNT geographic location is outside a predetermined radius threshold relative to the previously reported PNT geographic location.

20. The non-transitory computer-readable storage medium of claim 18, wherein the test criteria includes comparing the PNT geographic location to the previously reported PNT geographic location, and wherein the disruption condition is indicated when the PNT geographic location indicates unnatural movement compared to the previously reported PNT geographic location.
